(19) United States
(12) Patent Application Publication
(10) Pub. No.: US 2004/0184699 A1
(43) Pub. Date: Sep. 23, 2004

(54) Electro optical device with parallel sections for orthogonal polarization modes

(75) Inventor: Serdar Yeralan, Pleasanton, CA (US)

Correspondence Address: JERRY RICHARD POTTS, 3248 VIA RIBERA, ESCONDIDO, CA, 92029, US

(73) Assignee: DigiLens, Inc.

(21) Appl. No.: 10/767,923

(22) Filed: Jan. 29, 2004

Related U.S. Application Data
(63) Continuation-in-part of application No. PCT/US02/24568, filed on Aug. 1, 2002.
(60) Provisional application No. 60/309,738, filed on Aug. 1, 2001.

(51) Int. Cl. G02B 6/00

(52) U.S. Cl. 385/11

(57) ABSTRACT

An improved solution to achieving low PDL and low PDM in wavelength selective filter devices for use in fiber optic communications systems is disclosed. In one embodiment, an optical input signal is divided into orthogonal polarization components by a polarizing beam splitter. The two polarization components are provided to an Electrically Switchable Bragg Grating (ESBG) device. The polarization of one of the two components is rotated ninety degrees such that the two components enter the ESBG device having the same polarization orientation. At the output of the ESBG device, one of the two components is rotated ninety degrees, such that the polarization of the component so rotated is orthogonal to the polarization of the other component. The two components are then combined, using a polarizing beam combiner, and the combined signal is provided as an optical output signal.

### CROSS REFERENCE TO RELATED APPLICATIONS

This application is a continuation-in-part of International Application PCT/US02/24568 filed Aug. 1, 2002, which designated the United States. This application claims priority to U.S. Provisional Patent Application No. 60/309,738 entitled ELECTRO-OPTICAL DEVICE WITH PARALLEL SECTIONS FOR ORTHOGONAL POLARIZATION MODES filed Aug. 1, 2001 which is incorporated herein by reference for all purposes.

### FIELD OF THE INVENTION

The present invention relates generally to switchable optical components. More specifically, an electrically switchable Bragg grating device having parallel sections for orthogonal polarization modes is disclosed.

### BACKGROUND OF THE INVENTION

Domash, in U.S. Pat. No. 5,937,115, entitled “Switchable Optical Components/Structures and Methods for the Fabrication Thereof,” issued Aug. 10, 1999, which is incorporated herein by reference for all purposes, describes a family of electro-optical components comprising an optical waveguide fabricated on, or just under, the surface of a waveguide substrate, a layer of polymer dispersed liquid crystal material (PDLC) in which a Bragg grating has been formed, and a cover plate. The cover plate, waveguide substrate, or both, comprise electrodes for applying an electric field across the PDLC layer in order to rotate the orientation of the liquid crystal molecules and thus change the diffraction efficiency of the Bragg grating and/or the average refractive index of the PDLC layer. The components described by Domash comprise, therefore, an electrically switchable Bragg grating (ESBG). Such components are useful as wavelength-selective filters and attenuators in fiber optic communications systems.

Ashmead (WDM Solutions, January 2001) described a dynamic gain equalization device comprising a series of electrically switchable Bragg gratings (ESBG), each with a different peak wavelength, constructed in series along a planar optical circuit with a single waveguide core.

Components for use in fiber optic communications systems must have low polarization dependent loss (PDL) and polarization mode dispersion (PMD). PDL is defined as the variation in device insertion loss or attenuation as a function of the polarization state of the input light. PMD is similarly defined as the variation in phase shift or transit time through the device as a function of the polarization state of the input light. To satisfy the requirement for low PDL and low PMD, the performance of components for use in fiber optic communications systems must be essentially independent of the polarization state of the incident light. This condition is very difficult to achieve in any component incorporating an inherently birefringent material, such as a holographic polymer dispersed liquid crystal material or a nematic liquid crystal material.

One solution to achieving low PDL in liquid crystal based components for optical communications systems is to separate two orthogonal polarization states using a polarizing beam splitter, pass the resulting two beams of light through the liquid crystal device independently, and then recombine the two beams using a polarizing beam combiner. See, e.g., Sorin, et al., U.S. Pat. No. 6,208,774, entitled POLARIZATION INDEPENDENT LIGHT SWITCHING DEVICE BASED ON LIQUID CRYSTALS, issued Mar. 27, 2001. The polarization diversity approach has not, to the knowledge of the applicant, been applied previously to electrically switchable Bragg grating devices, such as those described by Domash and Ashmead.

### BRIEF DESCRIPTION OF THE DRAWINGS

The present invention will be readily understood by the following detailed description in conjunction with the accompanying drawings, wherein like reference numerals designate like structural elements, and in which:

FIG. 1 shows an exploded schematic view of an electrically switchable Bragg grating (ESBG) device 100.

FIG. 2 is a schematic view of one embodiment of an electrically switchable Bragg grating-based optical device 200 having parallel sections for orthogonal polarization modes.

FIG. 3 is a schematic view of one embodiment of an electrically switchable Bragg grating-based optical device 300 having parallel sections for orthogonal polarization modes.

### DETAILED DESCRIPTION

It should be appreciated that the present invention can be implemented in numerous ways, including as a process, an apparatus, a system, or a computer readable medium such as a computer readable storage medium or a computer network wherein program instructions are sent over optical or electronic communication links. It should be noted that the order of the steps of disclosed processes may be altered within the scope of the invention.

A detailed description of one or more preferred embodiments of the invention are provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An improved solution to achieving low PDL and low PDM in wavelength selective filter devices for use in fiber optic communications systems is disclosed. In one embodiment, an optical input signal, received via a single mode optical fiber, is divided into orthogonal polarization components by a polarizing beam splitter. The two polarization components are conducted in one embodiment via two polarization-preserving optical fibers to an Electrically Switchable Bragg Grating (ESBG) device. The polarization of one of the two components is rotated ninety degrees such that the two components enter the ESBG device having the same polarization orientation (i.e., the polarization of the first component is parallel to the polarization of the second component). In one embodiment, the ESBG device comprises one or more switchable gratings formed between a planar waveguide circuit, and a cover plate. In one embodiment, the ESBG may be formed in a layer of polymer dispersed liquid crystal. The cover plate, the planar optical circuit substrate, or both, have electrodes for applying electric fields across the ESBG. At the output of the ESBG device, one of the two components is rotated ninety degrees, such that the polarization of the component so rotated is orthogonal to the polarization of the other component. The two components are then combined, using a polarizing beam combiner, and the combined signal is provided as an optical output signal.

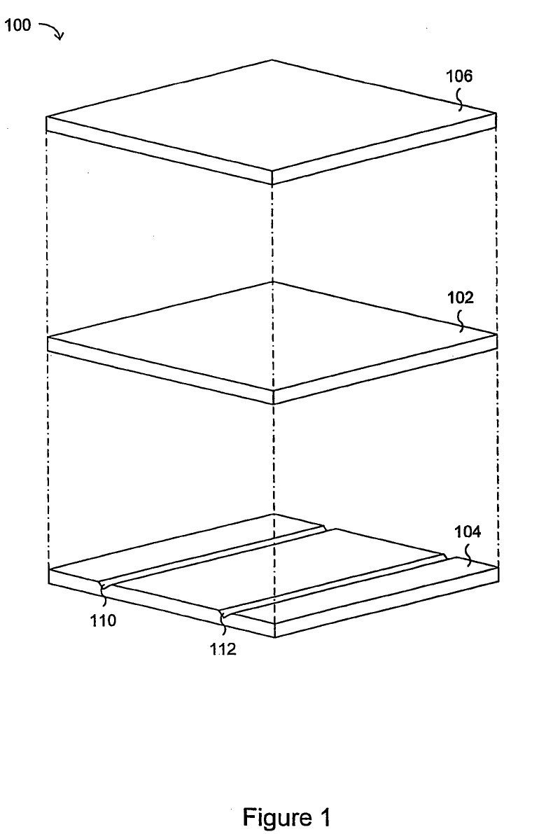

FIG. 1 shows an exploded schematic view of an electrically switchable Bragg grating (ESBG) device 100. A holographic polymer dispersed liquid crystal (HPDLC) layer 102 is sandwiched between a planar optical waveguide circuit 104 and a cover glass 106. The planar optical waveguide circuit 104 comprises two parallel waveguide cores 110 and 112. In other embodiments, the planar optical waveguide circuit 104 may comprise more than two parallel waveguide cores. A plurality of electrically switchable Bragg gratings (ESBGs) are fabricated in the HPDLC layer 102. In one embodiment, the fringe planes of the ESBGs are normal to the axis of the waveguide cores 110 and 112. Since the liquid crystal molecules within the HPDLC layer 102 align normal to the fringe planes, the molecules will be aligned parallel to the cores 110 and 112 if no electrical field is applied to the ESBGs. With the molecules aligned in this manner, the gratings will have no polarization dependent interaction with the light propagating in the waveguide cores 110 and 112. In one embodiment, the cover glass 106, waveguide circuit 104, or both, have thin film electrodes, not shown in FIG. 1, for imposing an electric field to control the ESBGs. In one embodiment, the electrode structures are as described in Provisional U.S. Patent Application No. 60/309,153, entitled “Electro-Optical Device with Sequential Sections for Orthogonal Polarization Modes,” filed Dec. 14, 2001, which is incorporated herein by reference for all purposes. In one embodiment, the electrode structures are as described in PCT Application No. PCT/US01/48294, entitled “Switchable Holograms,” which is incorporated herein by reference for all purposes. In one embodiment, the application of an electric field normal to the axis of the waveguide cores 110 and 112 will cause the liquid crystal molecules to rotate in the direction of the field, thus increasing the interaction between the grating and the light propagating in the waveguides.

In one embodiment, the input to and output from the ESBG device 100 are light signals coupled to the ends of the waveguide cores 110 and 112. In one embodiment, the respective light signals are coupled to the appropriate one(s) of waveguide cores 110 and 112 by aligning and bonding polarization preserving optical fibers to the ends of each respective core. In one embodiment, as discussed more fully below, additional components and paths are integrated onto the same substrate as the ESBG device 100. In such an embodiment, light signals may be coupled to the waveguide cores 110 and 112, as applicable, without requiring the use of polarization preserving optical fibers.

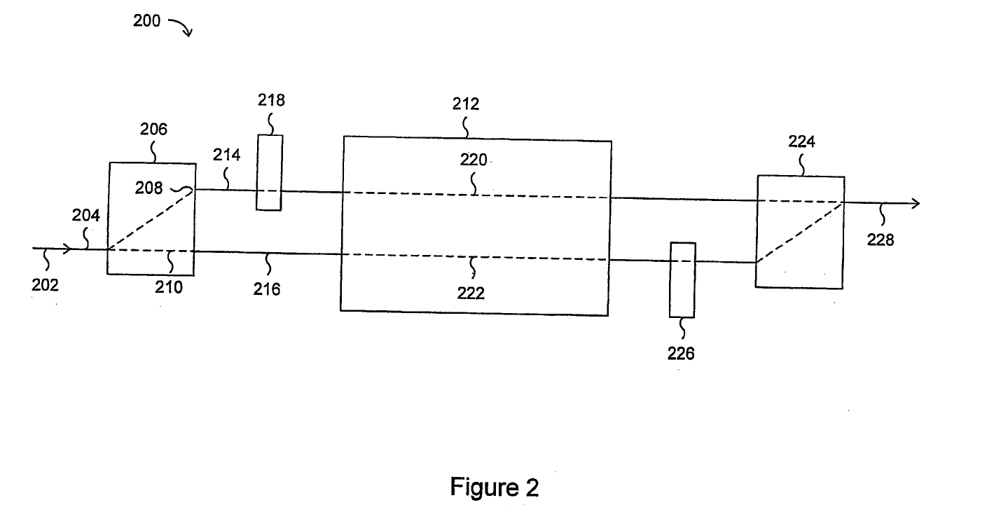

FIG. 2 is a schematic view of one embodiment of an electrically switchable Bragg grating-based optical device 200 having parallel sections for orthogonal polarization modes. In one embodiment, the optical device 200 comprises a wavelength selective filter device. The input optical signal 202 comprises randomly polarized light delivered via a single mode optical fiber 204. In one embodiment, the input optical signal 202 is generated by a light emitting diode (LED) or a semiconductor laser, such as a Fabry Perot laser, a Bragg laser, a distributed feedback laser, or some other laser or other suitable source. In one embodiment, a 50 mW or higher power laser is used. In one embodiment, lights signal in the C-band (1528 to 1561 nm wavelength) or L-band (1561 to 1620 nm) may be used. However, any light signal suitable for use in optical communications or signaling, generated by any suitable source, may be used.

In one embodiment, a polarizing beam splitter (PBS) 206 divides the input optical signal 202 into two signals 208 and 210 having orthogonal polarization modes. In one embodiment, the PBS 206 may comprise a cube prism with a dielectric coating, or a birefringent crystal. Techniques for making fiber-to-fiber polarizing beam splitters are well known in the industry. In one embodiment, the PBS 206 has an insertion loss less than 0.5 dB and a splitting extinction ratio around 20 dB. In one embodiment, the PBS 206 comprises a “Polarization Beam Combiner/Splitter, Grade A” manufactured by New Focus (USA). In one embodiment, the PBS 206 comprises a self imaging polarization splitter, such as those described in U.S. Pat. No. 5,852,691, which is incorporated herein by reference for all purposes. A self imaging waveguide polarization splitter also is described by L. B. Soldano et al., “Optical multi-mode interference devices based on self-imaging principles and applications”, J. Lightwave Tech. Vol. 13, No. 4, April 1995, at pp. 615-627. In one embodiment, the PBS 206 comprises a Y branch splitter, such as described by R. M. de Ridder et al. in “An integrated optic adiabatic TE/TM mode splitter on silicon”, IEEE Journal of Selected Topics in Quantum Electronics, Vol. 4, No. 6, November/December 1998, at pp. 930-937 and Y. Shani et al. in “Integrated optic adiabatic polarization splitter on silicon”, Appl. Phys. Lett. 56(2), 1990, at pp. 120-121. The above-cited references by Soldano et al., de Ridder et al., and Shani et al. are incorporated herein by reference for all purposes. In one embodiment, the use of either a self imaging waveguide polarization splitter or a Y branch splitter for PBS 206 allows for PBS 206 to be formed on the same substrate as one or more other components in the device 200, thereby eliminating the need for optical fiber links between such components.

In one embodiment, the divided input signals 208 and 210 are conducted to an ESBG device 212 via polarization preserving optical fibers 214 and 216, respectively. Polarization preserving optical fibers are available from many sources, such as Fujikura America, Inc. (Santa Clara, Calif.). A first one of the two signals, e.g., signal 208 as shown in FIG. 2, is rotated by 90 degrees by means of a polarization rotator 218 prior to being coupled to the ESBG device 212. In one embodiment, the polarization rotator 218 comprises a half wave retardation plate (HWP). In one embodiment, a half wave retardation plate available commercially from Melles Griot Photonics Components (Carlsbad, Calif.) is used. In one embodiment, polarization rotator 208 comprises a Faraday rotator, such as are available commercially from Isowave, Inc. of New Jersey. In one embodiment, polarization rotator 218 comprises a polarization converter based on the principle of Alternating Waveguide Section 2D/3D as disclosed in U.S. Pat. No. 5,398,845 to Van der Tol, and as further described by JJGM. Van der Tol et al. in “Realization of a Short Integrated Optics Passive Polarization Converter”, IEEE Photon. Tech. Letters, vol. 7, no. 8, August 1995, at pp. 893-895, both of which are incorporated herein by reference for all purposes. In one embodiment, polarization rotator 218 comprises a polarization converter based on poled electro optic polymers, e.g., as described in U.S. Pat. No. 6,011,6412 to S-Y Shin et al., entitled “Wavelength Insensitive Passive Polarization Converter Employing Electro Optical Polymer Waveguide”, and/or as described by M-C Oh et al. in “Integrated Optical Polarization Conversion Devices Using Electro Optical Polymers”, ETRI Journal, 18 no. 4, 1997, at pp. 287-299, both of which references are incorporated herein by reference for all purposes. In one embodiment, use of a polarization converter based on the principle of alternating waveguide section 2D/3D or a polarization converter based on poled electro-optic polymers enables such components to be integrated onto the same substrate as the ESBG device, thereby eliminating the need to use optical fiber links between such components and the ESBG device.

The two input signal components are conducted through the ESBG device via optical waveguides 220 and 222, respectively, and are modified by interaction with the ESBG elements in the manner well known to those of skill in the art, and as described more fully in U.S. Pat. No. 5,937,115 to Domash, incorporate herein by reference above. In one embodiment, other components and elements comprising a planar optical circuit, not shown in FIG. 2, may be integrated on the same substrate as the waveguides 220 and 222. Light propagating through the waveguide cores is modified by interaction with the ESBG layer. The form of modification may include broadband or wavelength selective attenuation, or phase change without attenuation. The degree of modification can be controlled through the application of voltages that alter the properties (such as refractive index or index modulation) of the ESBGs. Since both of the polarization components of the input signal propagate through the planar optical circuit in the same polarization mode, they are not affected by polarization-dependent performance, e.g., polarization dependent loss (PDL) or polarization mode dispersion (PMD), of the planar optical circuit and/or the ESBGs. Thus both polarization components of the input optical signal incur essentially identical modification. Since both components of the input signal 202 travel through the ESBG device 212 in the same polarization mode, they are not affected by the intrinsic PDL or PMD of ESBG device 212. In one embodiment, the polarization mode for light propagating through the ESBG device is TE (transverse electric), wherein the electric field vector is parallel to the surface of the planar waveguide circuit in the ESBG device 212. In one embodiment, other polarization modes, including transverse magnetic (TM), may be used. The two signal components exiting the ESBG device 212 are conducted to a polarizing beam combiner (PBC) 224, which combines the two components into a composite beam. In one embodiment, PBC 224 comprises a polarizing beam splitter configured or oriented so as to act as a polarizing beam combiner. In one embodiment, PBC 224 may be implemented using any of the techniques described above for implementing a polarizing beam splitter. The second of the two signal components is rotated by 90 degrees between the ESBG device 212 and the input to PBC 224 by operation of a second polarization rotator 226. In one embodiment, the first signal component is rotated by 90 degrees prior to entering the ESBG device 212 and the second component is rotated by 90 degrees after exiting the ESBG device 212 so that each channel goes through the rotation process once, with the result that any extinction ratio loss or insertion loss due to fusion splicing is balanced. In one alternative embodiment, the same signal is rotated once prior to entering the ESBG device and once after exiting the ESBG device, and the other component is not rotated. The combined optical output signal 228 of FIG. 2 is provided as output, having been modified by the ESBG device without dependence on the polarization state of the input optical signal 202.

As noted above, provided that components suitable for integration onto a single substrate with ESBG 212 are used, e.g., for PBS 206, polarization rotator 208, polarization rotator 226, and PBC 224, such components may be integrated onto the same substrate with ESBG 212, such as on a silicon substrate, eliminating the need to use optical fiber links to conduct light signals between the respective components. In this manner, a fully or more fully integrated implementation is possible.

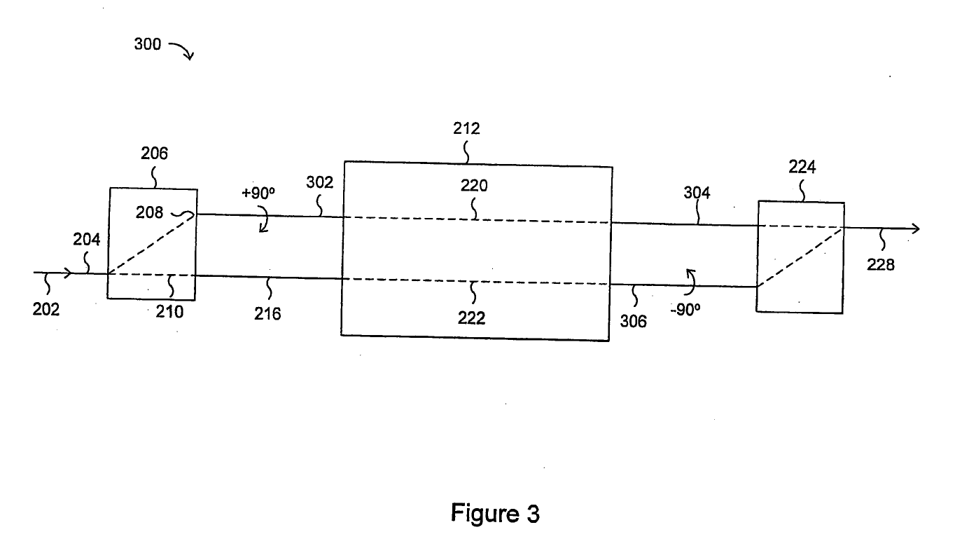

FIG. 3 is a schematic view of one embodiment of an electrically switchable Bragg grating-based optical device 300 having parallel sections for orthogonal polarization modes. The elements 202, 204, 206, 208, 210, and 216 are the same as the corresponding elements of FIG. 2. In the embodiment illustrated in FIG. 3, the polarization preserving optical fiber 214 and the polarization rotator 218 have been replaced by a polarization preserving optical fiber 302, which optical fiber 302 has been rotated by 90 degrees about its own axis (i.e., physically twisted about its own axis) prior to being aligned with and bonded to the input of the waveguide 220 of ESBG 212. In one embodiment, such rotation of the polarization preserving optical fiber 302 has the same effect as passing the light signal component 208 through the polarization rotator 218 in the embodiment shown in FIG. 2. That is, at the point at which the respective signal components enter the ESBG 212 the polarization state of the signal component delivered via optical fiber 302 is the same as, i.e., is parallel to, the component delivered via optical fiber 216. In one embodiment, the required rotation of optical fiber 302 is completed prior to splicing the optical fiber 302 to the ESBG 212. In one embodiment, fusion splicing or mechanical splicing may be used to splice the optical fiber 302 to the ESBG 212. Those of skill in the art will recognize that many techniques and procedures could be used to rotate, align, and splice the optical fiber 302 to the ESBG 212. In one embodiment, techniques based on using polarized input light and rotating the fiber until maximum or minimum extinction level is achieved are used.

Referring further to FIG. 3, the component light signals, with their polarization states aligned as described above, are routed through ESBG device 212 and are coupled to polarization preserving optical fibers 304 and 306 coupled to the output of ESBG device 212. In place of providing a second polarization rotator 226, as in the embodiment shown in FIG. 2, the optical fiber 306 provided for carrying the second component light signal is rotated physically by 90 degrees about its own axis prior to being aligned with and coupled to the polarization beam combiner 224. In this way, the polarization of the second component signal is once again orthogonal to the polarization of the first component signal, with the result that the polarization beam combiner 224 operates to combine the component signals to provide combined output signal 228, as described above in connection with FIG. 2.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. An electro optical device having approximately parallel sections for orthogonal polarization modes, comprising:
a beam splitter configured to receive an input light signal and to separate said input light signal into physically separated first and second component light signals, said first component light signal having a polarization that is approximately orthogonal to that of said second component light signal;
a first polarization rotator configured to receive said first component light signal and rotate the polarization of said first component light signal, such that the polarization of said first component light signal is approximately parallel to that of said second component light signal; and
an electrically switchable Bragg grating (ESBG) device comprising approximately parallel waveguides configured to receive said rotated first component light signal and said second component light signal.

2. An electro optical device as recited in claim 1, further comprising:
a second polarization rotator configured to receive said second component light signal from the output of said planar optical circuit and rotate the polarization of said second component light signal, such that the polarization of said second component light signal is approximately orthogonal to that of said rotated first component light signal; and
a beam combiner configured to combine said rotated first component light signal and said rotated second component light signal to provide a combined output signal.

3. An electro optical device as recited in claim 1, further comprising:
a second polarization rotator configured to receive said rotated first component light signal from the output of said planar optical circuit and rotate the polarization of said rotated first component light signal, such that the polarization of said rotated first component light signal is approximately orthogonal to that of said second component light signal; and
a beam combiner configured to combine said rotated first component light signal and said second component light signal to provide a combined output signal.

4. An electro optical device as recited in claim 1, wherein the beam splitter comprises a polarizing beam splitter.

5. An electro optical device as recited in claim 1, wherein the beam splitter comprises a self imaging waveguide polarization splitter.

6. An electro optical device as recited in claim 1, wherein the beam splitter comprises a Y branch polarization splitter.

7. An electro optical device as recited in claim 1, wherein the first polarization rotator comprises a half wave retardation plate.

8. An electro optical device as recited in claim 1, wherein the first polarization rotator comprises a Faraday rotator.

9. An electro optical device as recited in claim 1, wherein the first polarization rotator comprises a polarization converter based on the principle of alternating waveguide sections.

10. An electro optical device as recited in claim 1, wherein the first polarization rotator comprises a polarization converter based on poled electro optic polymers.

11. An electro optical device as recited in claim 1, further comprising a polarization preserving fiber optic link configured to carry said first component light signal from said beam splitter to said first polarization rotator.

12. An electro optical device as recited in claim 1, further comprising a polarization preserving fiber optic link configured to carry said rotated first component light signal from said polarization rotator to said ESBG device.

13. An electro optical device as recited in claim 1, wherein said ESBG device comprises:
a substrate;
a planar optical circuit formed on said substrate;
a cover glass layer; and
a holographic polymer dispersed liquid crystal layer sandwiched between said planar optical circuit and said cover glass layer.

14. An electro optical device as recited in claim 1, wherein said ESBG device comprises one or more electrodes configured to generate an electrical field sufficient to alter the state of the Bragg grating of said ESBG device.

15. An electro optical device as recited in claim 1, wherein said first polarization rotator is integrated onto the same substrate as said ESBG device.

16. An electro optical device as recited in claim 1, wherein said beam splitter is integrated onto the same substrate as said ESBG device.

17. An electro optical device as recited in claim 1, wherein said beam splitter, said first polarization rotators, said second polarization rotator, and said beam combiner are integrated onto the same substrate as said ESBG device, whereby said electro optical device comprises a fully integrated device and does not require the use of optical fiber links to conduct light signals between its components.

18. An electro optical device having approximately parallel sections for orthogonal polarization modes, comprising:
a beam splitter configured to receive an input light signal and to separate said input light signal into physically separated first and second component light signals, said first component light signal having a polarization that is approximately orthogonal to that of said second component light signal;
a first polarization rotator configured to receive said first component light signal and rotate the polarization of said first component light signal, such that the polarization of said first component light signal is approximately parallel to that of said second component light signal;
a planar optical circuit comprising:
a first waveguide configured to receive said rotated first component light signal;
a second waveguide, approximately parallel to said first waveguide, the second waveguide being configured to receive said second component light signal; and
a plurality of electrically switchable Bragg gratings, each of said plurality of electrically switchable Bragg gratings having a first state in which light passing through the grating is substantially unmodified by the grating and a second state in which light passing through the grating is modified by the grating;
wherein said planar optical circuit is configured such that light traveling through said first waveguide passes through one or more of said plurality of electrically switchable Bragg gratings and light traveling through said second waveguide passes through one or more of said plurality of electrically switchable Bragg gratings;
a second polarization rotator configured to receive said second component light signal from the output of said planar optical circuit and rotate the polarization of said second component light signal, such that the polarization of said second component light signal is approximately orthogonal to that of said rotated first component light signal; and
a beam combiner configured to combine said rotated first component light signal and said rotated second component light signal to provide a combined output signal.

19. An electro optical device having approximately parallel sections for orthogonal polarization modes, comprising:
a beam splitter configured to receive an input light signal and to separate said input light signal into physically separated first and second component light signals, said first component light signal having a polarization that is approximately orthogonal to that of said second component light signal;
an electrically switchable Bragg grating (ESBG) device comprising approximately parallel waveguides configured to receive said first component light signal and said second component light signal;
a first polarization preserving optical fiber configured to receive said first component light signal from said beam splitter and deliver said first component light signal to said ESBG device, such that said first component light signal enters said ESBG device having approximately the same polarization state as it had when it emerged from said beam splitter;
a second polarization preserving optical fiber configured to receive said second component light signal from said beam splitter and deliver said second component light signal to said ESBG device, said second polarization preserving optical fiber being rotated about its own axis prior to alignment and bonding to said ESBG device, such that the polarization of said second component light signal as it enters said ESBG device is approximately parallel to that of said first component light signal;
a beam combiner configured to receive said first component light signal via a third polarization preserving optical fiber and said rotated second component light signal via a fourth polarization preserving optical fiber, said fourth polarization preserving optical fiber being configured and aligned so as to deliver said rotated second component light signal to said beam combiner at approximately the same polarization state as it had when it emerged from said ESBG device and said third polarization preserving optical fiber being rotated about its own axis between said ESBG device and said beam combiner, such that said first component light signal is delivered to said beam combiner having a polarization that is approximately orthogonal to the polarization at which said rotated second component light signal is received at said beam combiner;
whereby said rotated first component light signal and said rotated second component light signal are combined to provide a combined output signal.

20. An electro optical device having approximately parallel sections for orthogonal polarization modes, comprising:
means for receiving the input light signal;
means for splitting the input light signal into a first component light signal and a second component light signal, wherein the first component light signal has a polarization state that is approximately orthogonal to that of the second component light signal;
means for rotating the polarization of the first component light signal, such that polarization of the rotated first component light signal is approximately parallel to that of the second component light signal;
means for providing said rotated first component light signal as input to a first waveguide of said ESBG device and for providing said second component light signal as input to a second waveguide of said ESBG device, said first and second waveguides being approximately parallel to each other, whereby said rotated first component light signal and said second component light signal interact with said ESBG device in parallel and emerge as a first component output light signal and a second component output light signal;
means for rotating the polarization of said second component output light signal, such that the polarization of said second component output light signal is approximately orthogonal to that of said first component output light signal; and
means for combining said rotated second component output light signal with said first component output light signal to create a combined output light signal.

21. A method for providing for the interaction of an input light signal with an electrically switchable Bragg grating (ESBG) device in a manner largely independent of the polarization state of the input light signal, comprising:
receiving the input light signal;
splitting the input light signal into a first component light signal and a second component light signal, wherein the first component light signal has a polarization state that is approximately orthogonal to that of the second component light signal;
rotating the polarization of the first component light signal, such that the polarization of the rotated first component light signal is approximately parallel to that of the second component light signal;
providing said rotated first component light signal as input to a first waveguide of said ESBG device and providing said second component light signal as input to a second waveguide of said ESBG device, said first and second waveguides being approximately parallel to each other, whereby said rotated first component light signal and said second component light signal interact with said ESBG device in parallel and emerge as a first component output light signal and a second component output light signal;
rotating the polarization of said second component output light signal, such that the polarization of said second component output light signal is approximately orthogonal to that of said first component output light signal; and
combining said rotated second component output light signal with said first component output light signal to create a combined output light signal.
